(19) United States
(12) Patent Application Publication
(10) Pub. No.: US 2015/0335521 A1
(43) Pub. Date: Nov. 26, 2015

(54) SYSTEM AND METHOD FOR PROPRIOCEPTIVE STIMULATION, MOVEMENT MONITORING AND CHARACTERISATION

(71) Applicant: Universidade De Aveiro, Aveiro (PT)

(72) Inventors: Vtor Pedro Tedim Ramos Cruz, Vila Nova De Gala (PT); Virgílîo Ferro Bento, Aveiro (PT); Joäo Paulo Trigueiros Da Silva Cunha, Porto (PT)

(21) Appl. No.: 14/410,917

(22) PCT Filed: Jul. 2, 2013
(86) PCT No.: PCT/IB2013/055419

§ 371 Date: Dec. 23, 2014

(30) Foreign Application Priority Data
Jul. 2, 2012 (PT) 106424

(51) Int. Cl. A61H 23/02

(52) U.S. Cl. CPC A61H 23/02

(57) ABSTRACT

System and method for movement proprioceptive stimulation, monitoring and characterization comprising: a component for proprioceptive action and another for movement characterization. Both components are coupled so that they can be used (worn) in outpatient treatment on the upper and lower limbs of the body side showing motor deficit.

This device can be applied in healthcare, particularly in neurorehabilitation, in basic or clinical science activities, in products aimed at recreational market segments (e.g. dancing, video games, interactive TV, 3D cinema) and in sports and motor performance improvement for competition purposes.

The system comprises a main module for movement control, proprioceptive stimulation and quantification, modules for movement control, proprioceptive stimulation and quantification and proprioceptive stimulation elements.

### TECHNICAL DOMAIN OF THE INVENTION

The present invention refers to a system for movement proprioceptive stimulation, monitoring and characterization, in the field of motor neurorehabilitation.

### BACKGROUND OF THE INVENTION

Spontaneous recovery subsequently to a condition, such as a stroke, is normally limited, which makes post-stroke rehabilitation therapies essential in the functional recovery of the individual. Technology applications to neurological and motor rehabilitation methods focus mainly on robotic and electromagnetic stimulation devices (competitors).

For electromagnetic stimulation, there are different application paradigms. However, results (motor recovery) obtained in clinical trials are modest when compared to traditional rehabilitation therapies based on repetition of specific tasks. Due to the nature of electrical stimuli, either invasive or noninvasive, these can only be applied under medical supervision which eliminates the possibility of outpatient use, thus reducing the intensity of rehabilitation.

Robotic devices allow continuous repetition of specific motor tasks, assisting the patient in the correct execution thereof. However, these devices are of high cost of production and operation, requiring specialized human resources, which prevents outpatient use and democratization. For this reason, they provide a reduced exposure to treatment and therefore a lower possibility of global health gains, as has been demonstrated in clinical studies. However, their use is promising in more restricted cases, as it allows continuous training of specific day-to-day tasks such as opening a door, or a bottle, among others.

The re-habilitation method and system based on the present invention (which shall be hereinafter designated SWORD—Stroke Wearable Operative Rehabilitation Devices) allow a high intensive training due to their outpatient use aiming at the repetition of specific tasks, and it is the only solution capable of providing biofeedback.

Yet compared with the complex high technology robotic devices, the method and system herein referred to as SWORD will lower production costs and require less manpower to operation, resulting in easier spread by patients in need, and maximizing possible health gains.

The method and system herein referred to as SWORD can be used in integrated marketable products (intervention/monitoring), as provided for in the original design of the device, or it may be applied separately in devices directed only to vibratory stimulation or to quantification and monitoring of movement quality.

The main application for this type of product is the area of healthcare, particularly the neurorehabilitation field. Potential users are, on the one hand, health institutions dealing with neurological patients, including rehabilitation centers and Neurology departments and, on the other hand, patients themselves. Conditions which may benefit from this technology are e.g. stroke, head and spinal cord trauma, lesions after neurosurgery, all with high annual incidence, prevalence and impact on morbidity measured by Quality Adjusted Life Years (QALYs).

In Europe, according to WHO data, health services spend about 5% of budget on the treatment of stroke patients and the annual value of Disability Adjusted Life Years (DALYs) is between 5 to 9 years per 1000 inhabitants.

Another segment is the basic or clinical science activity, wherein variations of products may be presented, developed as a standard vibratory stimuli management tool and motor quantification tools on an outpatient basis. It is a segment of smaller dimension but medium-term significant due to its possible benefits in the range of applications and validation of clinical indications for this technology.

The outpatient movement quantification system can also be applied to products aimed at entertainment market segments (e.g. dancing, video games, interactive TV, 3D cinema), in sports and motor performance improvement for competition purposes.

The present invention combines several unique characteristics within the Neurorehabilitation scope. Compared with the prior art, it allows:
increasing rehabilitation time without raising the production costs to the healthcare system
decreasing costs and time for caretakers and family
a new set of protocols which enable new and safe treatment procedures, which are practical and comfortable
a device easy to use and with a highly fast learning curve
individual and collective health gains
increased productivity within rehabilitation services
providing a system of marketable evolutionary products that are complementary to each other.

### DESCRIPTION OF PRIOR ART

Prior art rehabilitation methods, which allow obtaining better results in terms of functional recovery, share at least one of the following characteristics:
high training intensity
a therapy based on the repetition of specific motor tasks and
feedback on performance obtained.

These three characteristics are present simultaneously in the rehabilitation paradigm underlying the method and system herein referred to as SWORD, thus their outpatient use shall allow an increase on training intensity, monitored task repetition and its feedback to the patient, family and attending physician, gathering all conditions enhancing the achievement of an effective functional recovery.

Still regarding current prior art, technology applications to neurological and motor rehabilitation methods focus mainly on robotic and electromagnetic stimulation devices (competitors).

For electromagnetic stimulation, there are different application paradigms, however, results (motor recovery) obtained in clinical trials are modest when compared to traditional rehabilitation therapies based on repetition of specific tasks. Due to the nature of electrical stimuli, either invasive or noninvasive, these can only be applied under medical supervision which eliminates the possibility of outpatient use, thus reducing the intensity of rehabilitation.

Robotic devices allow continuous repetition of specific motor tasks, assisting the patient in the correct execution thereof. However, these devices are of high cost of production and operation, requiring specialized human resources, which prevents outpatient use and democratization. Due to this fact, they provide a reduced exposure to treatment and therefore a lower possibility of global health gains, as has been demonstrated in clinical studies.

Some prior art documents of the present invention are hereinafter described.

U.S. Pat. No. 5,575,761(A) describes a device for variable vibratory massage of different parts of the human body.

U.S. Pat. No. 6,093,164 (A) discloses a sleeve for applying low frequency and diffuse vibration onto the limbs.

U.S. Pat. No. 6,878,122 (B2) discloses a robotic device for motor facilitation and simulation through vibratory stimuli in affected areas of the body.

WO2008094485(A2) discloses a portable device for the application of vibrations and thermal variations in painful areas of the body.

WO2010028042(A1) discloses a portable device for the application of vibrations and thermal variations in painful areas of the body.

US2010004709(A1) discloses a device for increasing cerebral perfusion through stimulation of peripheral nerves with various stimuli and vibration of the head.

None of the above documents contains the full set of features present in the invention herein described such as:
the use of vibration stimuli as a non-invasive intervention source, in order to proprioceptively stimulate damaged Central Nervous System;
providing vibratory stimuli continuously and/or interspacedly with the possibility of amplitude and frequency modulation according to specifications of the assisting physician;
enabling the synchronous or asynchronous performance of the device network, a predefined stimulation sequence being used for the asynchronous case, which will be programmed in a clinical environment and defined according to the guidelines of the assisting physician;
providing feedback to the patient in real time and subsequently to the clinical group, on the quality of movement executed after the intervention. It is important to note that the term “quality of movement” is to be understood as its parameterization as translation and orientation of the limb in space, rather than the mere quantification of the translation, as if it were an actigraph;
elements of intervention apart from control modules;
outpatient use.

The device herein proposed is innovative, not only in its specifications, but also in terms of its approach to rehabilitation. According to the latest revisions of the prevailing rehabilitation paradigms in strokes, the method and system herein referred to as SWORD assert themselves as a new approach. The intervention of vibratory stimuli, either continuously or at predefined intervals, is not object of study in neurorehabilitation technology, but nevertheless, its CNS (Central Nervous System) excitatory ability has already been proven.

The combination of vibratory stimuli action with patient response assessment represents a further innovation.

Therefore the device and methods herein proposed correspond to an unique and emerging technology.

### DESCRIPTION OF THE DRAWINGS

FIG. 1—Shows an example of modular integration of the system herein referred to as SWORD, for the upper limb.

1. Main module located on the shoulder for movement control, proprioceptive stimulation and quantification on the shoulder girdle

2. Module for movement control, proprioceptive stimulation and quantification on the arm region

3. Module for movement control, proprioceptive stimulation and quantification on the forearm region

4. Module for movement control, proprioceptive stimulation and quantification on the hand region

FIG. 2—Constituent Units of each modular element of the system herein referred to as SWORD.

5. Movement quantification and characterization unit

6. Unit for global control, communication and synchronization among modules

7. Proprioceptive intervention unit

FIG. 3—Internal operation of constituent Units of each Module of the system herein referred to as SWORD. Movement quantification and continuous monitoring unit (5):

8. Gyroscope

9. Accelerometer

10. Magnetometer

11. Sensor Fusion block

12. Movement characterization block

Unit for global control, communication and synchronization among modules (6):

13. General control block

14. Communication and synchronization block

Stimulation or intervention unit (7):

15. Proprioceptive control and stimulus definition block

16. Elements for proprioceptive stimulation

FIG. 4—Example of the arrangement of the modules and stimulation elements on the upper limb.

FIG. 5—Example of the arrangement of the modules and stimulation elements on the lower limb.

17. Module for movement control, proprioceptive stimulation and quantification on the thigh region

18. Module for movement control, proprioceptive stimulation and quantification on the leg and knee region

FIG. 6—Example of the arrangement of the modules and stimulation elements on the torso.

19. Module for movement control, proprioceptive stimulation and quantification on the torso region, namely the abdomen

FIG. 7—Example of the conceptual model of earth and module axis systems used to estimate the rotation matrix.

20. xx axis of the earth axis system.

21. yy axis of the earth axis system.

22. zz axis of the earth axis system.

23. Rotation matrix transforming the earth axis system into the module axis system and vice-versa.

24. xx axis of the module axis system.

25. zz axis of the module axis system.

26. yy axis of the module axis system.

### DETAILED DESCRIPTION OF THE INVENTION

The rehabilitation method based on the device herein referred to as SWORD allows a high intensity straining due to its outpatient use, it is intended for the repetition of specific tasks, and is the only one able to provide biofeedback in terms of the characterization of the movement carried out and in terms of the quality and quantity thereof.

Yet compared with the complex high technology robotic devices, the method and system herein referred to as SWORD requires less manpower to operation and may be more easily spread by patients in need thereof, thus maximizing potential health gains.

The rehabilitation paradigm underlying the object of the invention, the method and system herein referred to as SWORD, is based on extracorporeal application of proprioceptive stimuli, either intermittently or continuously, of various kinds (vibration, thermal, pressure) onto the main joints of the affected side, on the one hand, and on the correct quantification and qualification of any type of movement performed in an outpatient setting during and after the stimulus. The integration and communication between the stimulation system and quantification system allow a dynamic configuration of the two components.

One may also export continuous monitoring data on the movement in order to assist the therapy decision in rehabilitation medicine.

The system may be described according to several levels of complexity. At a macrostructural level, it consists of segmental modules. Each of these modules is composed of Units, each having a primary function. Finally, each unit is composed of several blocks which articulate according to the function performed by the respective unit.

### Detailed Description of the Macro-Structure of the System

The system herein referred to as SWORD is usually composed of several interconnected modules. Each module is responsible for the proprioceptive stimulation and characterization of the movement carried out by a body segment. The number of modules to be used in each individual depends on the body segments intended to stimulate and from which quantitative and qualitative information on the movement performed on an outpatient basis is intended for collection.

Communication among modules is bi-directional. All modules communicate with each other and share information regarding the stimulation mode in use and movement performed. Thus, each module knows the current and past status of the other modules, thus allowing a dynamic configuration of the proprioceptive stimuli to be used. This communication methodology allows the proprioceptive stimulus to be applied only onto the body limb responsible for the erroneous execution of the motor task. Biofeedback transmitted could thus be directed only to a part instead of the generality of bodily elements, notifying the user in detail on the location of the error. Additionally, such communication is essential in order to update the biomechanical model at each time instant, since there is a direct dependency relationship between the several body elements.

Each of the individual modules (e.g. 1, 2, 3, 4, 17, 18, 19) is dedicated to stimulate a particular segment of the human body and to collect kinetic information from the same segment, as shown in FIG. 1. This information is communicated among modules, as illustrated in FIG. 1 for the upper limb. In each module such communication is established by the unit for global control, communication and synchronization among modules (6).

The main module (1) is the one closest to the center of body gravity and integrates the information collected by all modules of said limb, and controls the stimulation mode at each distal module and sets whether stimulation should occur simultaneously, randomly or according to predetermined and programmed patterns.

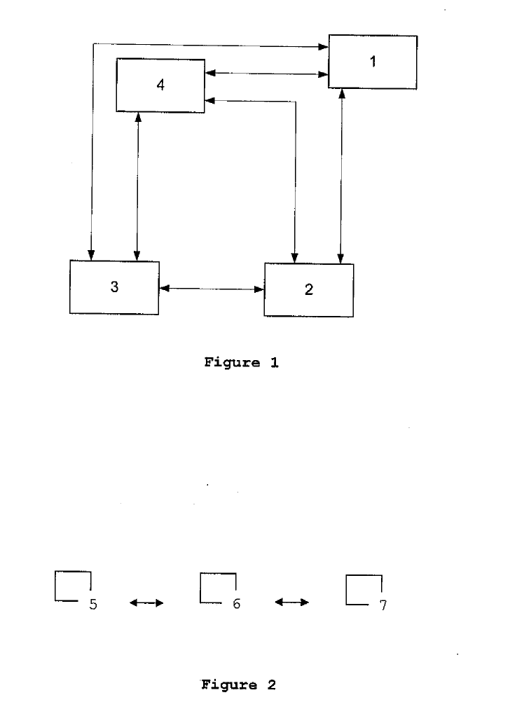

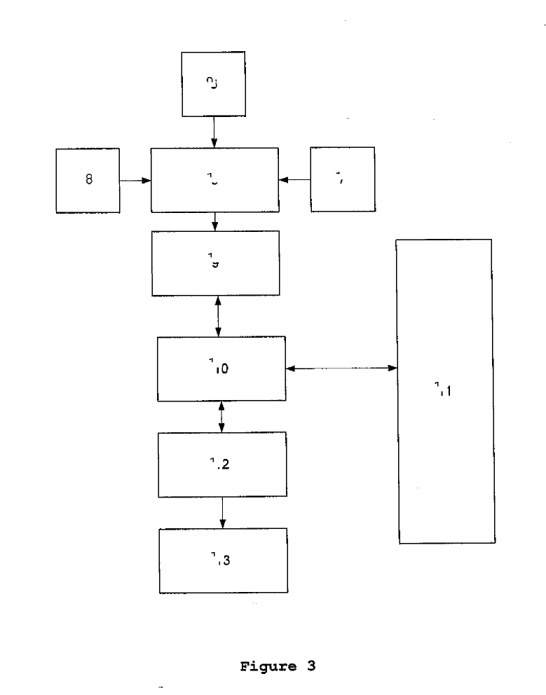

As for the internal operation of each module, the system typically consists of three components overlapping and connected as shown in FIG. 2: a continuous movement quantification and monitoring unit (5); a unit for global control, communication and synchronization among modules (6); and a stimulation or intervention unit (7). The internal components of each unit, the operation mode thereof and how they interconnect are described below and in connection to FIG. 3.

As far as the communication among modules is concerned, it may occur with or without wires, depending on the wearable solution chosen. In the case of wireless communication and synchronization among modules, this is done by low energy elements in order to maximize the device's autonomy.

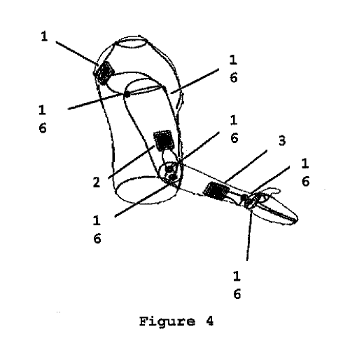

Thus, for the upper limb (FIG. 4), for example, the modules may be described as follows:
Module for movement control, proprioceptive stimulation and quantification on the shoulder girdle (1). In terms of movement characterization, this module is responsible for characterizing the movement performed by the shoulder. This module has control priority over the Modules surrounding it, denoted by 2 and 3. In terms of communication, module 1 is responsible for synchronizing the proprioceptive operating modes of 2 and 3.
Module for movement control, proprioceptive stimulation and quantification on the arm region (2). In terms of movement characterization, this module is responsible for characterizing the movement performed by the arm. Its proprioceptive operating mode is synchronized by means of the interface with module 1.
Module for movement control, proprioceptive stimulation and quantification on the forearm region (3). In terms of movement characterization, this module is responsible for characterizing the movement performed by the forearm. Its proprioceptive operating mode is synchronized by means of the interface with module 1.
Module for movement control, proprioceptive stimulation and quantification on the hand region (not shown in FIG. 4). In terms of movement characterization, this module is responsible for characterizing the movement performed by the hand. Its proprioceptive operating mode is synchronized by means of the interface with module 1.

For the lower limb (FIG. 5), for example, the modules may be described as follows:
Module for movement control, proprioceptive stimulation and quantification on the thigh region (17). In terms of movement characterization, this module is responsible for characterizing the movement performed by the thigh. Depending on the selected localization typology, it may be the main controlling element, or it may have its proprioceptive operating mode synchronized by means of the interface with another module.
Module for movement control, proprioceptive stimulation and quantification on the leg and knee region (18). In terms of movement characterization, this module is responsible for characterizing the movement performed by the leg. Its proprioceptive operating mode is synchronized by means of the interface with the remainder modules (e.g. 17 and 19), depending on the selected localization typology.
Module for movement control, proprioceptive stimulation and quantification on the ankle region (not shown in FIG. 5). In terms of movement characterization, this module is responsible for characterizing the movement performed by the ankle. Its proprioceptive operating mode is synchronized by means of the interface with the remainder modules, depending on the selected localization typology.
Module for movement control, proprioceptive stimulation and quantification on the foot region (not shown in FIG. 5). In terms of movement characterization, this module is responsible for characterizing the movement performed by the foot. Its proprioceptive operating mode is synchronized by means of the interface with the remainder modules, depending on the selected localization typology.

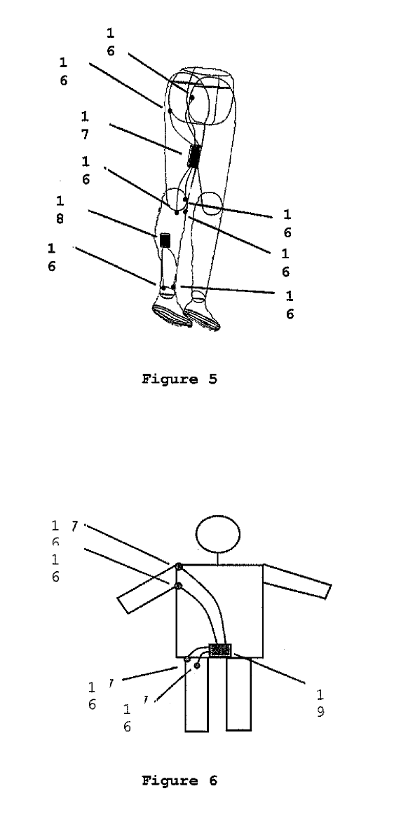

In certain situations additional modules located on the head, chest or abdomen regions may be required (FIG. 6) and they work in an integrated manner with the other modules, allowing the collection of global information on body movement, particularly the detection of falls and also allowing integrated patterns of stimulation of the upper limb, lower limb and torso. Its components, as well as the operating mode, are the same as for the remainder modules.

According to needs, the system may operate only on the upper limb, only on the lower limb, only on the torso, only on the head or with all possible segmental components or combinations thereof.

Depending on the needs for collecting kinetic or stimulation information, there may be a saving of modules at each segment. In this situation, the position of the proprioceptive stimulation elements (16) is maintained, but the total number of modules per system may be reduced.

### Detailed Description of Constituent Units of the Modules

Each continuous movement quantification and monitoring unit (5) includes gyroscopes (8), accelerometers (9) magnetometer (10), sensor fusion block (11) and a movement characterization block (12) and is responsible for all kinetic data collection from the respective segment and processing thereof, for the purposes of transferring them to the unit for global control communication and synchronization among modules (6).

Each unit for global control, communication and synchronization among modules (6) contains a general control block (13) and a communication and synchronization block (14).

The stimulation or intervention unit (7) includes a proprioceptive control and stimulus definition block (15) and proprioceptive stimulation elements (16), the latter being placed on the site, or sites, of the human body intended to stimulate.

As described in FIGS. 1 and 2, the articulation among the various constituent units of each module follows the following model: the movement quantification and characterization unit (5), by means of the interface with the global control unit (6) allows defining the type of stimulus intended to be applied by the proprioceptive intervention unit (7), depending on segment and body position and whether the movement performed has been the default movement or not.

### Detailed Description of the Elements and Blocks Composing the Units in Each Module

Elements 8, 9, 0.10 are collecting structures of kinetic information (quantitative and qualitative information), which project their data into the sensor fusion block (11).

Movement qualification is defined as characterizing the displacement of the limb in space in terms of translation and rotation. This qualification is obtained by merging the measurements from the magnetometers (10), accelerometers (9) and gyroscopes (8) incorporated in the device using stochastic estimators for such purpose. The movement is subsequently compared with the movement trained by the patient in a clinical setting at block 13. The parameterization of the trained movement is obtained through the device herein referred to as SWORD, in combination with traditional rehabilitation therapy. This information is stored in block 13.

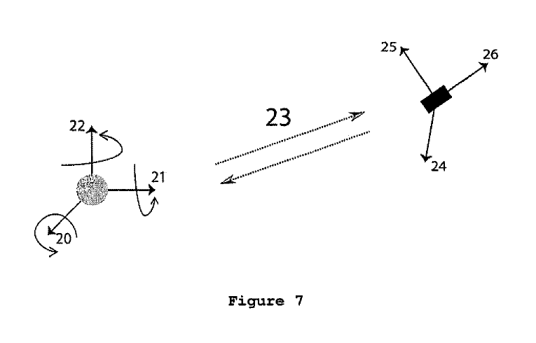

The sensor fusion block (11) represents the mathematical algorithm, which based on three independent measurements (acceleration, angular rotation and magnetic field) calculates translation and rotation in space of the module and body segment to which it is associated. This block 11 receives unidirectional information from elements 8, 9 and and projects it into block 12. The mathematical algorithm underlying the sensor fusion block is based on the estimate of a rotation matrix (23) between two reference axis, which relate to the earth's reference axis system and to the rotating module's axis system (FIG. 7). Therefore, the estimated rotation for the module will always be in reference to the earth's axis system. The rotation matrix (23) which converts the earth's axis system into the module's axis system (and vice-versa) is obtained by discrete integration in time of gyroscope (8) measurements concerning angular rotation. If measurements from the gyroscope (8) were noise-free, this mathematical operation would be sufficient to estimate the rotation of the module in three-dimensional space. However, as this does not happen, it is necessary to estimate the noise present in gyroscope measurements so there is a consequent compensation thereof. After this compensation, gyroscope measurements are obtained error-free, and obviously the rotation matrix (23) resulting from the discrete integration in time of gyroscope (8) measurements shall also be error-free.

The estimate of the error in the measurements from the gyroscope results from a geometrical comparison drawn between the earth's axis system and reference vectors obtained from the magnetometer (12) and accelerometer (9). The noise in measurements of angular rotation is also present in the earth's axis system, since this is obtained by multiplying the rotation matrix (23) by the module's axis system.

Although measurements from both blocks also contain noise, this will always be independent from that observed in measurements from the gyroscope (8). In order to estimate the error in the measurements relating to angular rotation associated with (22), the later is compared with the gravitational vector obtained by the accelerometer block (9). Comparison is performed by the external product, which will provide the magnitude and direction of the error in the measurements of angular rotation. Similarly, in order to estimate the error in the angular rotation measurements relating to (20) and (21) of the earth's axis system, the later is compared with the magnetic field vector obtained by the magnetometer block. The comparison is also made using the external product between both vectors. In order to complete the compensation process, both error components obtained are applied to a proportional-integral type controller from which error-free measures of angular rotation shall result and which may be used in time discrete integration of the rotation matrix (23). Depending on the rating required to represent the three-dimensional rotation of the module in space, the rotation matrix may be transformed into Euler angles or quaternions.

This error compensation process has the advantage of being efficient in terms of processing time required, which can be implemented in a microcontroller operating in real time. Another advantage lies in its proficiency in estimating the error in the measurements of the gyroscope.

The movement characterization block (12) represents the mathematical algorithm combining rotation and translation measurements from the sensor fusion block (11) with the biomechanical system representative of the user. This block displays vectors as output which mathematically describe the movement performed. This block 12 receives unidirectional information from block 11 relative to translation and rotation in space of the segment intended to be characterized in terms of movement. Block 12 sends and receives information to and from block 13. The mathematical algorithm transforms, by means of the rotation and translation operations, each vectorial element of the biomechanical system. The transforming element represents the rotation of a reference axis in three-dimensional space and may be present as quaternions, rotation matrices, or Euler angles. The transformed element may be any position of interest in the biomechanical system defined within three-dimensional space.

Block 13 (FIG. 3) is the general control block responsible for the aggregation and analysis of information received by the three blocks 12, 14 and 15. Block 13 sends and receives information to and from blocks 12, 14 and 15. Information at each module is of two types: internal to the module, when coming from blocks 12 and 15; and external to the module (from other modules) when coming from block 14 which is responsible for the communication and synchronization among modules. Information received at block 13 is on the characterization of the movement from other body segments to be rehabilitated. The information sent to block 13 refers to the characterization of movement of the segment relative to the module.

The internal logic is established through the use of a microcontroller which is the main component of the general control block (13) of the unit for global control, communication and synchronization among modules (6).

The movement carried out, characterized by the dynamics on points of interest defined and calculated at the movement characterization block (12) is compared with metrics from a motor performance perceived as being normal. Information regarding a deviation in the quality of the movement performed is converted into a proprioceptive stimulus, specified according to the body element which caused an abnormally performed movement.

Block 13 sends the dynamics definition of the applicable proprioceptive stimulus to block 15. Block 15 performs the interface between block 13 and proprioceptive stimulation elements (16).

The proprioceptive control and stimulus definition block (15) adjusts the modulated signal from the general control block (13) so as to obtain an efficient transduction for the proprioceptive stimulation elements (16). In the case of stimulation being based on vibration, the signal from the microcontroller shall be adapted in terms of current so as to be properly replicated in topology by vibration motors.

### Detailed Description of Communication Modes Among Modules and with the exterior

As far as the communication with modules is concerned, it may occur with or without wires, depending on the wearable solution chosen. In case of wireless communication/synchronization among modules, this is done by low energy elements in order to maximize the device's autonomy.

Main modules are to be understood as, for example, the module placed on the shoulder, in the case of the upper limb, and the module placed on the thigh in case of lower limb. The remainder modules communicate with each other via an internal communication network. All modules are provided with a transmitter and receiver. Main modules are provided with information storage systems.

The extra-module communication takes place among the main modules and the analysis software of the physicist responsible for the treatment plan. This communication is bi-directional and allows obtaining data concerning outpatient use from the device handled by the user. It also allows configuring module network in terms of movement characterization and stimuli definition according to the treatment plan specified by the physicist. The internal communication network exchanges information concerning rotation and translation of each sensory element in three-dimensional space, in order to allow for a mapping of various body segments in a complete biomechanical model, able to represent movement dynamics, to take place in the movement characterization block (12) of each module. The exchange of information among modules also includes the definition of proprioceptive stimuli being applied in each module. This component allows a rhythmical proprioceptive stimulation, since each module knows the sequence and timing of each proprioceptive stimuli in each module.

### Detailed Description of Possible System Parameterizations and Configurations

The device also allows its rapid configuration through communication between the main module and a personal computer, using for this purpose a software specifically developed. In terms of device configuration, it is possible to set the stimulation mode from continuous to intermittent and, should the latter be selected, it is possible to configure the intervention range. Another possibility is configuring the amplitude of the stimulus, should these be vibration-based, and should they occur synchronously or asynchronously across all modules. This software also displays movements performed by the patient after stimuli and the assessment thereof compared with movements made in clinical setting. Dynamic configuration of module network on the upper limb is made e.g. by the main module placed on the shoulder. Dynamic configuration of module network on the lower limb is made e.g. by the main module placed on the thigh. Main modules are responsible for the aggregation of information from the network which, combined with the previous definition of therapy, allows a better adjustment of proprioceptive stimulus to the relevant situation. The previous definition of therapy is performed by the software available to the physicist performing synchronization with the network by means of both main modules.

### Detailed Description of System Power Supply

In a preferred embodiment, each module includes a portable power supply that will allow using the device for several hours or more. Total autonomy shall depend on the configuration of the device in terms of intervention mode. Batteries may be included in the same housing of modules and are preferably rechargeable via USB connection to a computer or to a power outlet (through the use of a specific adapter).

### Detailed Description of Possible Proprioceptive Stimuli and Location Thereof

Devices for stimuli application (e.g., vibration, tactile, thermal, painful stimuli, among others). In case of vibration stimulus, it may be carried out by means of vibrating motors controlled in terms of stimulus amplitude and frequency by means of the voltage applied across its terminals. Setting the stimulation is performed by combining three variables: vibration frequency, vibration amplitude and interval between stimuli. If the operating mode is specified as continuous, the definition of the stimuli will depend only on two variables: vibration frequency and vibration amplitude.

Positioning of proprioceptive intervention elements will depend on the configuration selected and on the limb intended to rehabilitate: upper or lower limb. Should vibratory stimuli be used, one possibility is to place a vibration motor at each bone eminence in a position close to the main joints of the upper limb (shoulder, elbow, wrist, carpus and hand) and lower limb (hip, knee, ankle, tarsus and foot).

### Examples of Use, Associated Advantages and Impact on Neurorehabilitation

The use of this device right from an early stage after a stroke, and with no time restriction, may result in major benefits for Neurorehabilitation and, by democratizing access to this technology, a social impact and objective gains in healthcare shall be possible. This contribute is enhanced by other features such as lower cost of production and operation when compared to other technologies, energy autonomy and the possibility of outpatient use, handled by family members and in the future being embedded in garments.

Taking the rehabilitation process of patients with neurological deficits after a stroke into consideration, the application of this technology enables a new generation of processes herein identified:

1) traditional rehabilitation plans may now be enhanced through outpatient use of the device herein referred to as SWORD

2) all outpatient activity may now be monitored, both in real time and pre-recorded modes, using for such purpose, for example, Bluetooth technology in its low power consumption version.

3) new algorithms for clinical decision may be created based on monitoring data provided by the system and method herein referred to as SWORD

4) rehabilitation plans may be designed and tested which progressively include more outpatient activities without loss of therapeutic intensity

The application of the system and method herein referred to as SWORD allows a radical change. For the first time, new devices may come to life with the following characteristics:
vibratory stimulation
instruments for applying vibratory and proprioceptive stimuli in all joints of the upper and lower limb
integrated activity of all stimulators allowing programming activation sequences
stimuli adjusted automatically according to movement quantity and/or quality detected in the body part under rehabilitation
global and segmental movement quantifier
qualitative characterization of movement patterns performed in all limb segments when in use
integration of movement proprioceptive stimulation, quantification and qualification instruments
integrated into a user-friendly garment in individuals with hemiplegia due to central nervous system damage
directly programmable
remotely programmable
onsite use registration
online use registration
clinical analysis tools for the movement to assist decision making in rehabilitation plan
rechargeable long-term batteries (>24 h)

The present invention shall thus allow outpatient use combining the possibility of vibratory stimulation and continuous characterization of movement performed by a deficient body segment, as well as the provision of information collected to the patient and responsible physicists through specific software.

1. A system for movement proprioceptive stimulation, monitoring and characterization for outpatient coupling to limbs, or limbs and torso of the human body, comprising:
one or more movement control, proprioceptive stimulation and quantification modules comprising a movement quantification and monitoring unit;
a unit for global control, communication and synchronization among modules;
a proprioceptive stimulation or intervention unit connected to one or more proprioceptive stimulation elements, said modules being in bidirectional interconnection to each other.

2. The system according to claim 1, wherein the movement quantification and monitoring unit comprises a gyroscope sensor, an accelerometer sensor and a magnetometer sensor.

3. The system according to claim 1, wherein the unit for global control, communication and synchronization among modules is programmed to, according to displacement in space, in terms of translation and rotation of the human body limb to which the respective module is coupled, set the type, intensity and range of stimuli to be applied by the proprioceptive intervention unit.

4. The system according to claim 1, wherein the movement quantification and monitoring unit comprises a sensor fusion block interconnected to said sensors said sensor fusion block comprising a movement characterization block interconnected to said sensor fusion block.

5. The system according to claim 1, wherein the unit for global control, communication and synchronization among modules comprises a general control block and a communication and synchronization block.

6. The system according to claim 1, wherein the proprioceptive stimulation or intervention unit comprises a proprioceptive control and stimuli defining block for connection to said proprioceptive stimulation elements.

7. The system according to claim 1, wherein the unit for global control, communication and synchronization among modules is additionally programmed to apply stimulation simultaneously, randomly or according to predetermined and programmed patterns.

8. The system according to claim 1, wherein the unit for global control, communication and synchronization among modules is additionally programmed to detect falls.

9. The system according to claim 1, wherein the unit for global control, communication and synchronization among modules is programmed to, according to deviation from predefined values, displacement in space in terms of translation and rotation of the human body limb to which the respective module is coupled, set the type, intensity and range of stimuli to be applied by the proprioceptive intervention unit.

10. The system according to claim 1, wherein the unit for global control, communication and synchronization among modules is programmed to, from measurements obtained by said sensors, discretely include a rotation matrix which, subsequently to the correction of the error in said measurements, allows obtaining the displacement in space in terms of translation and rotation of the human body limb to which the respective module is coupled.

11. The system according to claim 1, wherein one or more modules are coupled to the shoulder, to the arm, to the forearm, to the hand, to the thigh, to the knee and leg, and/or to the torso, namely the abdomen.

12. The system according to claim 1, wherein the module closest to the body's center of gravity is the main module programmed to integrate the information collected by all modules of that limb.

13. The system according to claim 1, wherein the modules are programmed to rhythmically produce proprioceptive stimulation, each module knowing the sequence and timing of each proprioceptive stimulus, synchronized with the other modules.

14. A method for movement proprioceptive stimulation, monitoring and characterization comprising:
coupling to limbs, or limbs and torso of the human body, one or more movement control, proprioceptive stimulation and quantification modules comprising a movement quantification and monitoring unit;
providing a unit for global control, communication and synchronization among said modules;
connecting a proprioceptive stimulation or intervention unit to one or more proprioceptive stimulation elements, and
providing bidirectional interconnection to and among said modules.
